(19) United States
(12) Patent Application Publication
(10) Pub. No.: US 2008/0152846 A1
(43) Pub. Date: Jun. 26, 2008

(54) Molded array board for attaching jewels on decoration paper and method for attaching jewels using the same

(75) Inventor: Bok Jin Sa, Namyangju-City (KR)

Correspondence Address: GWIPS;Peter T. Kwon, Gwacheon P.O. Box 72, 119 Byeolyang Ro, Gwacheon City, Gyeonggi-Do, 427-600, omitted

(73) Assignee: Hana Co., Ltd.

(21) Appl. No.: 11/702,603

(22) Filed: Feb. 5, 2007

(30) Foreign Application Priority Data
Dec. 22, 2006 (KR) 10-2006-0132629

(51) Int. Cl. B32B 33/00

(52) U.S. Cl. 428/32.71; 428/314.2

(57) ABSTRACT

A method for attaching jewels and a molded array board for attaching the jewels to decoration paper are invented. The jewels or studs can be attached to the surface of clothes, handbags or other accessory-related products. The molded array board comprises the space-arranging bosses (2, 2′) protruding in a repetitive array above a board-shaped array substrate (1). The jewel placing recesses (3, 3′) are formed in the concave spaces between the protruding space-arranging bosses (2, 2′) above the array substrate (1). The mutual overlapped spacing between the jewel placing recesses (3, 3′) allows to mutually touch the adjacent circumferences of jewels (10, 10′) placed into the jewel placing recesses (3, 3′) each other.

### BACKGROUND OF THE INVENTION

1. Field of the Invention

The present invention relates to a molded array board for attaching jewels to a decoration paper that is used to decorate clothes, handbags or other accessory-related products and a method for attaching jewels using the same. More specifically, it is related to the process of attaching jewels or studs to the decoration paper, being arranged with no gaps between the jewels or studs exposed on the decoration paper. This process is not only improving the quality of decoration, but also performing the fine and delicate patterns. Thus, the productivity is significantly improved because the small size of the jewels or studs can be attached quickly in large quantity.

2. Description of the Related Art

Recently, in order to embody a design having splendor and character, clothes or handbags have been made by attaching artificial or natural jewels or studs to their surface.

Such jewels or studs enhance a feeling of solidity unlike the conventional spangled fabric. So, they render a more sophisticated and beautiful image while the object decorated with them can be ennobled further by the color, luster and reflection factor unique to the jewels.

Such jewels or studs are normally attached to decoration paper, which is then attached to the surface of the coat, pants, handbag or other accessory-related product. In case of the coat or pants, the partial decoration is used to highlight a certain portion. The partial decoration of such clothes is finished in forms of various characters or designs. In case of the handbag, the entire surface is decorated with jewels or studs to render a splendid overall image.

The methods used to attach the jewels or studs to such decoration paper include a manual individual attaching work and combination attaching work using a jig. The manual work is the attaching means of the jewels literally one by one to the surface of fabric. The combination attaching work is a placing means of the jewels or studs into the pattern slots. The jig forms the predetermined shapes of the jewels or studs for simultaneously attaching.

The aforementioned manual work is possible to make the dense attachment of jewels to express classy and fine patterns and designs. But, it has drawbacks in work not only the time consuming, but also the significantly low productivity. It causes to increase the product cost due to the increasing of the labor cost. It is also impossible to have mass-product because each item needs a specialized work processed by the skilled worker.

On the other hand, the attaching means of a jig with pattern slots has a problem. Due to the interstices of jig slots, there is large gaps occurred between the jewels. It is impossible to obtain not only the uniform and dense patterns of jewels, but also the elaborate and realistic expression. It is very difficult to handle the smooth curve treatment or delicate end portion treatment in the case of expressing a curved pattern or design.

### SUMMARY OF THE INVENTION

To overcome the aforementioned problems, it is an object of the present invention to provide a molded array board for attaching the jewels to a decoration paper and a method for attaching the jewels using the same. The molded array board is provided for arraying octagonal or dodecagonal jewels or studs with their edges touching each other. The jewels or studs arrayed in shapes of various patterns or designs are attached to the decoration paper all at once by using the molded array board. So that, there is no gaps occurred between the jewels or studs in the decoration paper, which has provided the fine quality of densely arranged jewels or studs. Even though a worker is unskilled, the worker can easily produce the identical fine quality of decoration paper by using the molded array board. So, it is improved the speed of production greatly to mass production. It is also possible to express the various patterns or characters and design the highly dense arrangement. Further, it is possible to satisfy the requirement of the classiness, splendor and elaborateness.

### BRIEF DESCRIPTION OF THE DRAWINGS

FIG. 1 is a perspective view showing a jewel molded array board according to the present invention.

FIG. 2 is a perspective view showing an enlarged jewel molded array board that is inserted the jewels according to the present invention.

FIGS. 3a to 3d are process diagrams showing the process for attaching jewels according to the present invention.

FIG. 3a is a sectional view showing the initial insertion of jewels in the molded array board.

FIG. 3b is a sectional view showing the placement of the jewels using a sponge.

FIG. 3c is a sectional view showing the separating of jewels from the molded array board by using a parting paper.

FIG. 3d is a sectional view showing the jewels attached on the decoration paper.

FIG. 4 is an illustrative view showing how the jewel decoration paper is attached to a handbag according to the present invention

FIG. 5 is an illustrative view showing how the jewel decoration paper is attached to the clothes according to the present invention.

### DESCRIPTION OF THE PREFERRED EMBODIMENT

Hereinafter, a preferred embodiment of the present invention will be described in detail accompanying with the drawings.

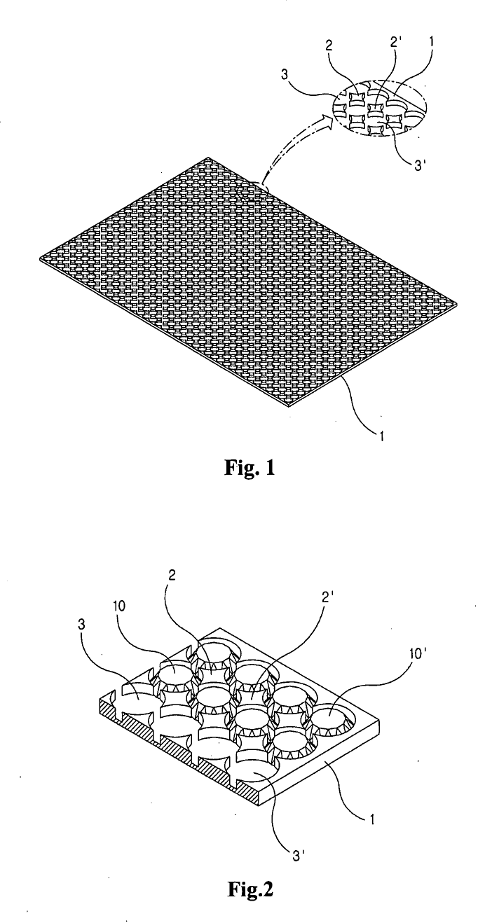

FIG. 1 is a perspective view showing a jewel molded array board according to the present invention, and FIG. 2 is a perspective view showing an enlargement of jewels inserted in a jewel molded array board according to the present invention.

First, take a look for the construction of a molded array board according to the present invention. A board-shaped array substrate (1) is provided with space-arranging bosses (2, 2′) protruding in a repetitive array, and an array of jewel placing recesses (3, 3′) located in the concaved spaces between the protruding space-arranging bosses (2, 2′).

The spacing between the centers of jewel placing recesses (3, 3′) is formed such a manner that the circumferences of adjacent jewels (10, 10′) placed in the jewel placing recesses (3, 3′) are mutually contacted each other.

Let see how the jewels are attached by using such a mold array board. First, place a molded array board having space-arranging bosses that are formed in repetitive array and jewel placing recesses that are indirectly formed in the spaces between the space-arranging bosses.

Next, insert jewels or studs that have shapes of circular, octagonal or dodecagonal as seen on plane, in the jewel placing recesses of the molded array board.

Next, attach a parting paper having an adhesion layer on the bottom to the top molded array board after arranging the jewels or studs inserted therein to bond the top face of the jewels or studs to the adhesion layer.

Finally, separate the parting paper adhered the jewels or studs from the molded array board, and places this to the fabric as a decoration paper, and then heat and presses them. Due to the heating, the hardened adhesion layer formed on the bottom of the jewels is fused so that the jewels are attached densely onto the fabric of the decoration paper.

The molded array board and method for attaching the jewels using the same is applied for densely attaching the jewels. The feature of the molded array board will be described in detail with the accompanying drawings.

The present invention is possible to make decoration paper having a jeweled decoration made up of various patterns or designs on a handbag, clothes and other accessories, or to obtain decoration paper that has jewels or studs attached densely on the whole surface of the fabric. It is possible to work more speedily by using an extra work tool and producing the decoration paper arranged densely without gaps or spaces between jewels.

Namely, as a work tool for accomplishing a jewel attaching method according to the present invention, a separately manufactured molded array board is used. On the molded array board, it provides the space-arranging bosses (2, 2′) protrude in a continuous array at a predetermined interval on the top of panel-formed array substrate (1). The concave shaped jewel placing recesses (3, 3′) are indirectly formed in the spaces between these space-arranging bosses (2, 2′).

Since the jewel placing recesses (3, 3′) have opened sides between the neighbors that have no boundary, the jewels (10, 10′) or studs inserted in the jewel placing recesses (3, 3′) are contacted each other, so that there is no gaps between neighboring jewels (10, 10′).

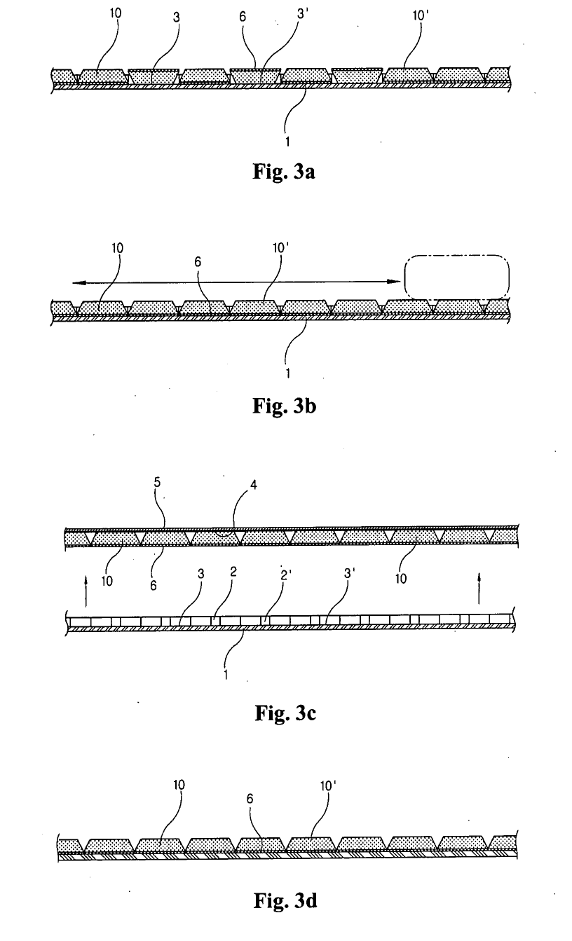

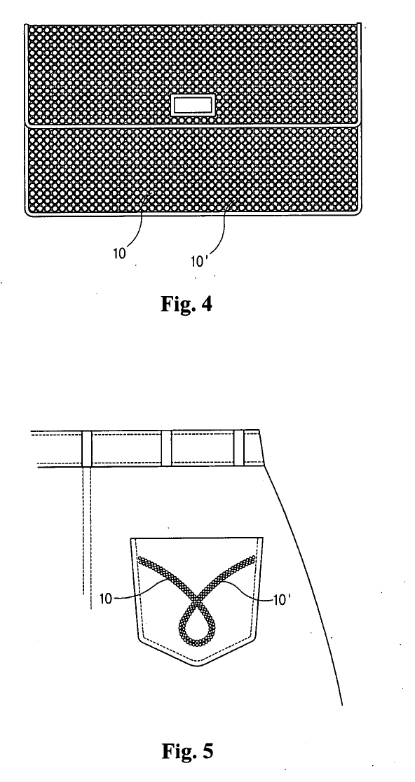

Namely, if the small size of jewels or studs with shapes of circular, octagonal or dodecagonal as seen on plane were poured onto a molded array board and shaking the molded array board, single jewel (10, 10′) is inserted and placed into the jewel placing recesses (3, 3′) as shown in FIG. 3a. In this condition, if the top of the array substrate (1) is swept by using a very soft sponge, the left-over jewels that were not inserted into the jewel placing recesses (3, 3′) by shaking action are swept aside to be inserted into the remained empty jewel placing recesses (3, 3′).

At this time, since a hardened adhesion layer (6) is formed in advance on the bottom of the jewels (10, 10′) or studs, the jewels (10, 10′) that were inserted into jewel placing recesses (3, 3′) should have their positions adjusted so as to be oriented with the hardened adhesion layer (6) facing downward, that is, with the adhesion layer (6) contacting the bottom side of the jewel placing recesses (3, 3′). To accomplish this, as shown in FIG. 3b, if the top array substrate (1) is swept repeatedly many times with a sponge, normally in the case of jewels (10, 10′) having a trapezoidal cross-sectional shape with the bottom surface larger than the top, if the jewel is inserted in the proper orientation it offers very little resistance to the force of the sponge, so there is no change in position. On the other hand, jewels (10, 10′) inserted in reverse direction are forcibly turned over by contacting with the sponge, so they are naturally inverted into the proper orientation in the jewel placing recesses (3, 3′).

In this condition, the worker has to inspect whether all jewels (10, 10′) are properly placed. In such an inspection process, the jewels (10, 10′) inserted upside-down can correct their positions to the proper orientation by simple manual work.

In this way, when the jewels (10, 10′) are inserted and placed in the jewel placing recesses (3, 3′) of the array substrate (1), a parting paper (5) having a size corresponding to the whole surface of the top array substrate (1) is attached. An adhesion layer (4) has been pre-formed on the bottom of the parting paper (5), so if the parting paper (5) is attached uniformly on the top array substrate (1), the jewels (10, 10′) or studs have their top faces attached to the adhesion layer (4).

Therefore, as shown in FIG. 3c, if the parting paper (5) is removed from the array substrate (1) by unnatural force, the jewels (10, 10′) or studs are separated from the array substrate (1), namely from the jewel placing recesses (3, 3′), all at once while remaining attached uniformly to the parting paper (5).

If such a parting paper (5) is placed on the fabric of the decoration paper and is heated while being pressed from both top and bottom, the hardened adhesion layer (6) formed in advance on the bottom face of jewels (10, 10′) is fused and attached to the surface of the fabric.

Therefore, as described above, when the fabric and jewels (10, 10′) are completely adhered by fusion of the hardened adhesion layer (6), the parting paper (5) is removed from jewels (10, 10′) to obtain a classy decoration paper that has jewels (10, 10′) or studs arranged densely, as shown in FIG. 3d.

The parting paper in such a condition is densely decorated without any gaps at all between attached jewels (10, 10′) or studs. So, it is possible to obtain a product in which jewels or studs are densely attached on the entire surface of the handbag, as shown in FIG. 4. As shown in FIG. 5, a product is presented as an example in which the characters and designs of clothes are expressed by jewels or studs. So, it is possible to achieve the splendid and classy aesthetic feelings from these products. Also, in the case of designing the various logos and emblems by attaching the jewels or studs, it is possible to express more elaborately and exquisitely by jewels or studs arranged densely.

According to the present invention as described above, the molded array board and method for attaching the jewels using the same is possibly used for dense attachment of jewels to decoration paper. It is possible to provide high-quality decoration paper having elaborate and high-density jewel or stud attaching surfaces. Even though an unskilled worker can accomplish identical high-quality decoration paper by using the molded array board, it is economically advantageous and production speed is greatly improved. So, it is possible to have mass production. In addition, since it is possible to express various patterns, characters or designs through the dense attachment method, it is possible to simultaneously satisfy further improved classiness, luxury and elaborateness.

Although the present invention has been described in detail with reference to its presently preferred embodiment, it will be understood by those skilled in the art that various modifications and equivalents can be made without departing from the spirit and scope of the present invention, as set forth in the appended claims.

What is claimed is:

1. A molded array board for densely attaching jewels to a decoration paper comprising:
a plurality of space-arranging bosses (2, 2′) protruding in a repetitive array formed above a board-shaped array substrate (1),
a plurality of recesses (3, 3′) formed concaved spaces for placing jewels between said protruding space-arranging bosses (2, 2′) above the array substrate (1), and
a mutual overlapped spacing between neighbored jewel placing recesses (3, 3′), so that the circumferences of neighbored jewels (10, 10′) placed in the jewel placing recesses (3, 3′) are mutually contacted each other.

2. A method for attaching jewels by using a molded array board for densely attaching jewels to a decoration paper, the method comprising steps of:
placing the molded array board, which has formed space-arranging bosses repetitively and jewel placing recesses between the space-arranging bosses,
inserting jewels or studs, which have shapes of circular, octagonal or dodecagonal, into the jewel placing recesses of said molded array board,
attaching a parting paper, which has an adhesion layer on the bottom, on the molded array board after arranging said jewels or studs, so that the jewels or studs are adhered to said adhesion layer,
separating the parting paper adhered the jewels or studs from the molded array board, and placing the parting paper as the decoration paper to the fabric,
heating and pressing said fabric placed the decoration paper, so that a hardened adhesion layer on the bottom of each jewel is fused, and
attaching all jewels or studs to the fabric in a fashion of a dense arrangement.
